(19) United States
(12) Patent Application Publication
(10) Pub. No.: US 2015/0203171 A1
(43) Pub. Date: Jul. 23, 2015

(54) Bicycle Pedal Mechanism

(71) Applicant: William ANDREWS, Cambewarra, New South Wales (AU)

(72) Inventor: William Andrews, Cambewarra (AU)

(21) Appl. No.: 14/413,973

(22) PCT Filed: Jul. 10, 2013
(86) PCT No.: PCT/AU2013/000766

§ 371 Date: Jan. 9, 2015

(30) Foreign Application Priority Data
Jul. 11, 2012 (AU) 2012902965
Aug. 31, 2012 (AU) 2012903760
Dec. 31, 2012 (AU) 2012905686

(51) Int. Cl. B62M 3/04; B62M 3/06; B62M 3/08

(52) U.S. Cl. CPC B62M 3/04; B62M 3/08; B62M 3/06

(57) ABSTRACT

A pedal assembly mountable on a bicycle crank arm associated with a bicycle drive assembly; the pedal assembly comprising: a pedal which is operably connected to a retaining member; the retaining member including a first end and a second end and on one side a spigot which engages the crank arm to enable support of the pedal assembly by the crank arm; the pedal including a first connection which engages the first end of the retaining member and a—second connection which engages the second end of the retaining member, wherein the first and second connections allow the pedal to move relative to the retaining arm during rotation of the crank arm.

### BACKGROUND

The present invention relates to an improved drive assembly for push bicycles and more particularly relates to improvements in a drive pedal systems. The invention further relates to a bicycle pedal which is capable of generating increased torque and energy for a given energy input provided by the rider. The invention further relates to a pedal assembly for a bicycle which increases mechanical advantage and generates greater torque compared to the same rider load applied to existing pedal assemblies. The invention further relates to a new bicycle pedal, capable of retrofitting to known a crank arm of a bicycle drive system and which increases mechanical advantage and generates greater torque compared to the same rider load applied to existing pedal assemblies.

### PRIOR ART

Push bicycles are propelled by the action of a rider applying load via pedals attached to a crank arm which extends to a primary drive shaft. The drive shaft is connected to a primary sprocket which imparts drive to at least one rear wheel sprocket via a drive chain. When the rider applies load to a pedal this induces a moment or torque at the primary drive shaft. This applied load is then transferred via the drive chain to rear wheel drive. Torque is the product of a load applied at one point and the distance from that load point to a rotation axis. As the load increases the torque increases for the same moment arm distance. As the moment arm increases, a reduced load can generate the same torque as an increased load on a shorter crank arm. The loading applied to the pedal required to impart drive will be affected by such parameters as ground contour, wind, the weight of the rider and drag between the wheels and the surface on which the bicycle is travelling. In a conventional bicycle, the distance between the pedal connection axis of the crank arm and the primary drive shaft is fixed by the length of the pedal arm. The length of the crank arm is limited by the distance between a ground surface and the primary drive shaft to ensure that on a down stroke, the pedal is well clear of the ground surface sufficient to allow pedal arm rotation. The objective is to maximize the mechanical advantage within the constraints of the operating space of the crank system.

Many attempts have been made in the past to increase the mechanical advantage in bicycle drive systems. Attempts have included extending the crank arm to gain more torque for the same load and thereby increase the mechanical advantage. Whilst there have been a number of attempts to increase the torque of a bicycle crank system to gain mechanical advantage, nearly all have involved a mechanism that axially increases the length of the crank arm to provide greater torque to the primary shaft of the drive system. Other systems have employed an externally mounted lever and pivot system that induced greater forces into the drive system.

The known drive assemblies in which attempts have been made to increase mechanical advantage and thus torque have a number of disadvantages.

The mechanisms attempting to increase torque involved in the prior art fall into a number of categories:

1. Mechanisms which cause a crank arm length variation during rotation.

2. mechanisms which induce greater force to the drive system during rotation.

3. mechanisms that allow a crank arm to vary its length to selected fixed lengths.

Variable length crank arms have included internal mechanisms, designed to control and order various aspects of the prior art drive systems to cause crank arm variation. These mechanisms are generally complex, involving many moving parts subject to particularly high stresses. Bearing in mind that the components are relatively small, one of the main problems with variable length crank arms, has been the compromise between parts being large enough to withstand the high stresses experienced by the various drive mechanisms and also support structure, but small enough to provide an acceptable alternative drive system. Another significant problem with these variable length systems is that whilst on paper they show significant crank arm extension to impart much greater rotational forces and therefore torque to the drive system, in practice they experience significant mechanical energy losses in operation occasioned by the action of the crank arm retracting in a generally upwards direction whilst the rider is attempting to force the pedal arm in a generally downwards direction during the last quarter of the crank arm rotation to a vertical down position. As a result of the opposing forces experienced during the rotation, they significantly cancel out the gains of a longer crank arm. Another significant problem with the extendible crank arms is noise generated by the various drive mechanisms loading and unloading during the course of a rotation under high stresses. The above described systems are bulky and heavy compared to traditional crank systems. They also require significant lubrication of moving parts and are also subject to dust and grit invasion of those moving parts.

Mechanisms having external components such as levers and pivots that interact with the crank arms also experience significant problems. They are cumbersome, relatively heavy, expensive to manufacture and bulky and when compared to traditional solid rigid crank arm systems, they can experience unwanted movement and noise due to the additional pivot points. They also suffer from unwanted structural flexing whilst also experiencing irregular pedal rotational paths.

The prior art also teaches the use of crank arms that can be adjusted during operation moving to various fixed lengths. Also known is a system where a rider's feet control a mechanism that can adjust the crank arm length whilst riding the bicycle. In this example the rider is able to locate spring loaded retaining pins in various locating holes along the crank arm to select and retain various crank arm lengths using the feet of the user. In operation without some form of indicating system to acknowledge the various length positions and a suitable pin to hole alignment position, this task would require a significant amount of practice and skill.

One of the problems with the prior art assemblies attempting to increase the crank length is that they are often physically bulky to house the necessary components as a result of which the crank arm dimensions are significantly greater. The pedals are spaced significantly further apart than traditional fixed length pedal arms. This causes the rider's feet often to be placed unacceptably further apart than usual.

In summary the known prior art inventions individually or collectively as described all experience significant problems even though they attempt to provide a more efficient alternative to the traditional fixed length arm. There is a long felt want in the industry to provide improvements in bicycle drive systems which increase mechanical advantage with a minimum of parts and which is relatively economic to manufacture and simple to operate.

It can be seen form the aforesaid that although in the past, many attempts have been made to improve the performance of the bicycle crank systems by reducing the amount of effort required from the rider, these prior attempts to increase energy from the bicycle crank have been largely ineffective. Bicycle manufacturers have sought to improve bicycle performance by using lighter materials and improved gearing systems. Prior attempts to improve crank performance have not resulted in sufficient performance gain. Three approaches to drive system modifications adopted with an objective of increasing mechanical advantage are described below.

One approach is to employ an extending crank arm system to improve leverage around the crank centre of rotation for improved torque. The disadvantage of extending the crank arm is that it creates a greater oval shaped circumference or distance that the pedals have to travel (the pedal track). In practice, when compared to a traditional crank system, the increased circumference also increases the pedal speed because of the increased distance travelled for the same revolution. To offset this, the rider needs to change to a higher gear to slow the pedal speed to that of a traditional crank system. The higher gear required however negates the perceived torque gained.

Another approach was to provide a mechanism causing a pedal to vary its distance from its point of attachment to a crank arm and accordingly its distance from the crank centre. When the crank arm is oriented in the half way down position the increased distance causes greater leverage around the crank centre and accordingly improves torque. This concept however suffers the same disadvantages as the use of an extending crank arm, i.e. increased pedal distance and speed for the same revolution.

In another approach a pedal platform of a drop pedal is positioned horizontally below an axis line of a traditional pedal axis point of a crank arm. In practice, the pedal platform hangs below and can swing around the traditional axis point of connection of a crank arm. The lower platform of the drop pedal mimics a traditional pedal track only slightly lower and around the same crank centre. In practice the drop pedal platform from the half way down position of the crank arm swings progressively away from the crank centre as it travels down and accordingly provides progressively greater torque. The disadvantage is that from the vertical up position of the crank arm to the halfway down position, the pedal platform starts closer to the crank centre resulting in a shorter crank arm providing less torque until the half way down position. Accordingly, the perceived gain of the second quarter is negated by the first quarter producing less torque to the halfway down position of the crank arm.

There is a need to improve the prior art assemblies and to overcome the disadvantages which exist in those assemblies. There is also a need to provide pedal drive assemblies having increased mechanical advantage but without the complexity of design and disadvantages referred to above. More specifically there is a need to increased torque and mechanical advantage in pedal assemblies but without changing pedal track distance during rotation of a crank arm to provide actual performance gain.

### INVENTION

With this in mind, the present invention provides a bicycle pedal assembly which is capable of generating increased torque and energy for a given energy input provided by the rider. The invention further provides a pedal assembly for a bicycle which increases mechanical advantage without complicating the drive mechanism and which generates greater torque compared to existing drive pedal assemblies. The invention further provides a new bicycle pedal, which improves mechanical advantage without complex adjustment to the crank arm mechanisms and which is capable of retrofitting to known bicycle crank systems.

The present invention seeks to ameliorate the shortcomings of the prior art by providing an improved pedal assembly for push bicycles which can generate increased torque and energy output for a given energy input provided by the rider without increasing pedal track distance. The invention further provides a pedal assembly for a bicycle which increases mechanical advantage compared to existing pedal drive assemblies.

In its broadest form the present invention comprises:

a pedal drive assembly for a bicycle; the assembly comprising a pair of crank arms each having a first end connected to a drive shaft and a second end connected to a pedal assembly; the pedal assembly including a pedal body mounted to a retaining member via swivel connections, the swivel connections allowing each pedal body to at least partially rotate relative to the retaining member; wherein as the crank arms rotate an increase in torque is achieved by advancing of the pedal during at least part of the arc of rotation of the crank arms, while maintaining a rotational circumference substantially the same as that defined by a pedal connected directly to the crank arm.

In its broadest form the present invention comprises:

a pedal assembly for a bicycle, the pedal assembly comprising first and second ends and intermediate there between;

a pedal body which includes a tread which receives a rider's foot;

the first and second ends each comprising a coupling which is connected to the pedal body;

the first end coupling comprising a spigot which engages a retaining member and the second end coupling comprising a linkage arm which engages the pedal body and a second end which engages the retaining member;

the retaining member engaging a connecting spigot including a bearing which engages the retaining member and a shaft which connects to a crank arm of said bicycle; wherein as the crank arm rotates the pedal moves relative to the retaining member such that at least for part of a revolution of the crank arm the pedal advances and retracts relative to the retaining member.

According to one embodiment the first end coupling provides an offset allowing the pedal body during rotation to at least partially rotate relative to the retaining member and for at least part of its rotation increasing a distance between a drive shaft axis and an axis through said connecting spigot. According to a preferred embodiment, the tread body includes a tread surface which receives a rider's foot.

According to an alternative embodiment the connections include swivel linkage arms each engaging a shaft which locates in the pedal body an intermediate portion and a secondary shaft extending therefrom which engages openings in the retaining member. The intermediate portion comprises a boss which undergoes partial rotation within an arc defined by opposing formations on the retaining member. In an alternative embodiment, the swivel linkage arms are mutually engaged by a transverse member and have extending therefrom a single shaft which locates centrally in the pedal body. Preferably, the pedal body and tread are manufactured in a mould from a plastics or rubberized material. Other hard compound materials may also be selected for use with the pedal assembly.

In another broad form the present invention comprises:

a pedal assembly for a bicycle drive assembly comprising;

a pedal having first free end and a second end which engages a mounting assembly;

the mounting assembly comprising at least one shaft having a first end engaging the pedal and a second end engaging a retaining member via at least one rocker arm; the retaining member including a recess which receives a spigot, the spigot including a bearing which co-operates with the retaining member and a threaded shaft which engages a crank arm associated with the drive assembly; wherein, when the crank arm rotates, the pedal moves through an arc defined by co-operation between the retaining member and at least one linkage arm such that during at least part of the rotation of the crank arm the pedal moves beyond a transverse axis through the junction of a spigot shaft and the crank arm.

Preferably the pedal allows the tread body on which a rider's foot is placed upon rotation to extend beyond a transverse axis through the connection for at least a part of a full rotational path of the crank arm. Preferably the transverse axis and plane of the tread area are substantially parallel so that the pedal advances in co-operation with the linkage arms about the transverse axis as the crank arm rotates.

As the crank arm rotates about the drive axis, the pedal which, is connected to the distal end of the crank arm via the retaining member, moves between a first location in which at least part of the pedal extends distally beyond a connection axis through the coupling member to a maximum extent in a direction along the crank arm and a second location in which the pedal extends proximally along the crank arm. The arrangement including the retaining member, allows the crank arms to rotate in a 360 degree plane about primary drive shaft and simultaneously allows the pedal assembly to rotate about the axis of the spigot which engages the crank arm.

Throughout the specification a reference to crank arm will be taken to be a reference to the member of a bicycle drive assembly in which a proximal end is connected to a primary transverse drive shaft and a distal end to a pedal which is integral with a coupling. Throughout the specification a reference to coupling, may be taken as a reference to a connection which is integral with a pedal and joins the pedal to the crank arm or a connection in which the pedal swivels or rotates relative to a retaining member.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims. It will be convenient to hereinafter describe the invention in relation to a metal section in the present exemplary application. However, it is to be appreciated that the invention may be constructed from other materials.

### BRIEF DESCRIPTION OF DRAWINGS

The present invention will now be described in more detail according to a preferred but non limiting embodiment and with reference to the accompanying illustrations, wherein:

FIG. 1 shows a perspective exploded abbreviated view of a bicycle drive assembly including a drive sprocket, frame and crank arm and including a pedal assembly according to a preferred embodiment.

FIG. 2 shows a side elevation view of a crank arm and pedal assembly of FIG. 1 with pedal assembly in a first orientation.

FIG. 3 shows with corresponding numbering an elevation view of the crank arm and pedal assembly of FIG. 1 in a second orientation with the pedal advanced forward.

FIG. 4 shows an elevation view of the pedal assembly mounted on a crank arm and the attitude of the pedal assembly during stages of crank arm rotation through 90 degree increments and rotation circumferences of the conventional crank arm track compared to the circumferential track defined by the pedal assembly according to the invention.

FIG. 5 shows a drop pedal and extending crank arm defining a comparison of pedal tracks in 90 degree rotational increments.

FIG. 6 shows an enlarged elevation view of the pedal assembly mounted on a crank arm and the attitude of the pedal assembly at the top of the arc of rotation of the crank arm.

FIG. 7 shows a perspective view of the pedal assembly of FIG. 1 isolated from the crank arm according to one embodiment.

FIG. 8 shows an enlarged perspective view of a pedal assembly mounted on the crank arm according to one embodiment.

FIG. 9 shows a perspective exploded view of a pedal assembly according to an alternative embodiment.

FIG. 10 shows an enlarged view of the spigot of the assembly of FIG. 9.

FIG. 11 shows and end view of the spigot of FIG. 9.

FIG. 12 shows a side elevation view of one spigot assembly of FIG. 9.

FIG. 13 shows an exploded side view of the pedal assembly of FIG. 9

FIG. 14 shows a perspective view of a pedal assembly according to an alternative embodiment.

FIG. 15 shows a side elevation view of the pedal assembly of FIG. 14 with the pedal advanced forward.

FIG. 16 shows a side elevation view of the pedal assembly of FIG. 14 and the attitude of the pedal assembly during stages of crank arm rotation through 90 degree increments and rotation circumferences of the conventional crank arm track compared to the circumferential tracks defined by the pedal assembly according to an alternative embodiment of the invention.

FIG. 17 shows an enlarged side elevation view of the pedal assembly of FIG. 14 with the pedal as it appears when the crank arm is at the 12 and 6 o'clock positions.

FIG. 18 shows an enlarged side elevation view of the pedal assembly of FIG. 14 with the pedal as it appears when the crank arm is at the 9 o'clock position

FIG. 19 shows an enlarged side elevation view of the pedal assembly of FIG. 14 with the pedal as it appears when the crank arm is at the 3 o'clock position.

### DETAILED DESCRIPTION

The present invention to be described below in more details provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. It is to be appreciated that the invention is not limited to the particular assembly described. The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description.

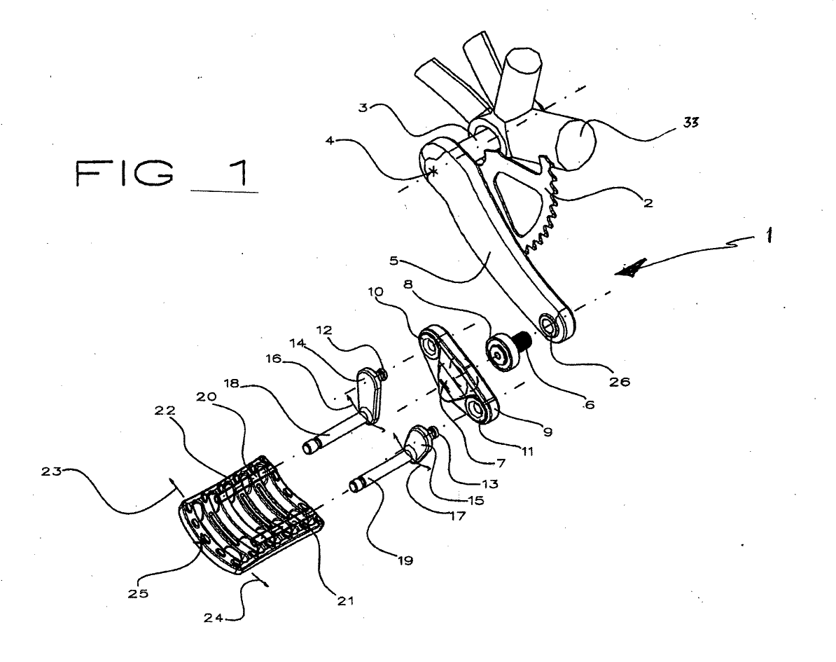

Referring to FIG. 1 there is shown a perspective exploded view of a bicycle drive assembly 1 including a pedal assembly according to a preferred embodiment. Bicycle frame 33 engages main shaft 3 which receives and retains sprocket 2 and crank arm 5. Axis 4 passes through crank arm 5, frame 33 and sprocket 2. At the opposite end of crank arm 5 is threaded hole 26, which receives and retains spigot 6. Spigot 6 is retained at one end within bearing 8. At its opposite end the spigot 6, has a thread which enables the spigot to be screwed into hole 26 of crank arm 5. Spigot 6 connects the pedal assembly of the present invention to crank arm 5. Bearing 8 is retained within retaining member 9 and allows rotation of retaining member 9 relative to fixed spigot 6 and connected crank arm 5. Bearing 8 allows retaining member 9 to rotate relative to spigot 6 and to maintain a generally horizontal attitude during rotation of crank arm 5 and spigot 6. Bushes 10 and 11 are retained in retaining member 9 and receive and retain co operating spigots 13 and 12. Spigots 12 and 13 are respectively connected and retained at the proximal ends of depending arms 14 and 15. Engagement of spigots 12 and 13 into respective bushes 10 and 11 allows spigots 12 and 13 to rotate thereby allowing swing arms 14 and 15 to swing through an arc of rotation in the direction of arrows 16 and 17.

Extending normally from distal ends of arms 14 and 15 are spigots 18 and 19 of respective swing arms 14 and 15. Spigots 18 and 19 extend from the opposite side from which spigots 12 and 13 extend and engage bushes 20 and 21 of pedal platform 22. This engagement, allows spigots 18 and 19 of respective swing arms 14 and 15 to rotate within bushes 20 and 21 of pedal platform 22 whilst providing a connection and a connection and support mechanism between retaining member 9 and pedal platform 22. The rotational connection of the spigots 12 and 13 of swing arms 14 and 15 within bushes 10 and 11 of retaining member 9 and corresponding spigots 18 and 19 which engage bushes 20 and 21 of pedal platform 22 allows swing arms 14 and 15 to swing or rotate according to corresponding curved bi directional arrows 16 and 17. This results in connected pedal platform 22 when under load to urge swing arms 14 and 15 in the direction of arrow 24. The resulting movement of pedal platform 22 in the direction of arrow 22 causes it to move away from crank centre 4, therefore providing a mechanical advantage.

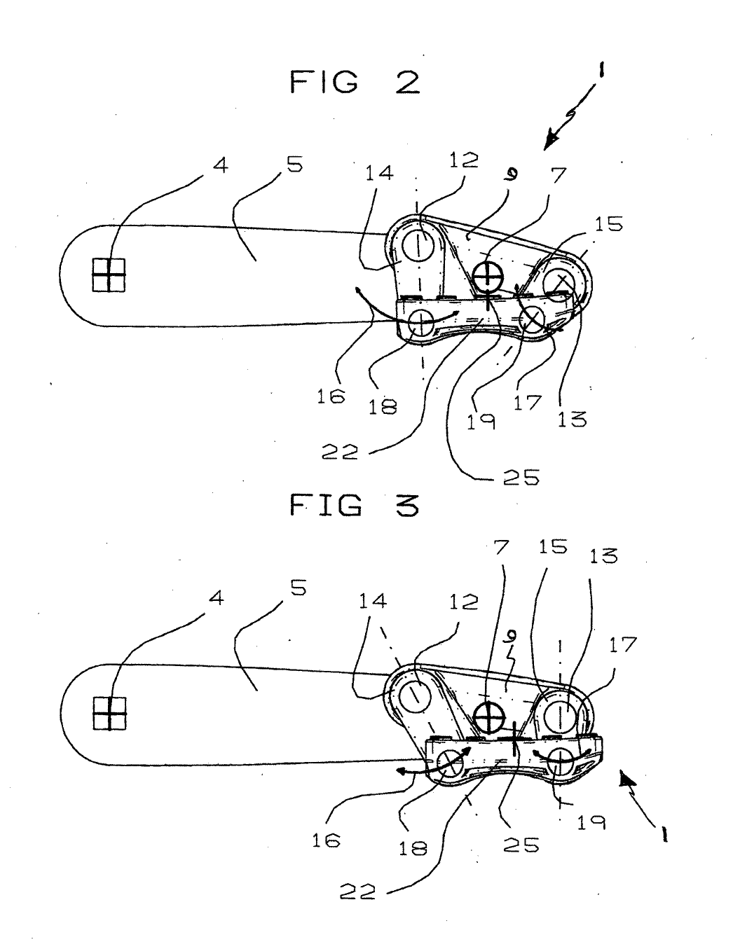

FIG. 2 shows with corresponding numbering a side elevation view of the crank arm and pedal assembly 1 of FIG. 1 with the pedal assembly in a first orientation. In practice when riding a bicycle with the pedal assembly according to the invention, downward forces from the rider causes the swing arms 14 and 15 to urge pedal platform 22 laterally relative to retaining member 9. FIG. 2 shows the pedal 22 in a disposition in which centre 25 of pedal 22 is co planar with axis 7 in that both lie initially in the same vertical plane when pedal 22 is in a retracted position. In that attitude, spigot 12 and spigot shaft 18 are disposed in generally the same vertical plane. Swing arm 14 in this case is disposed vertically. The aforesaid geometry of the swing arm 14 and location of pedal 22 results in an orientation of swing arm 15 so that an axis through spigot 19 and spigot 13 are offset relative to a vertical plane. In that case, swing arm 15 is swept back relative to the position of spigot 13. Arm 14 is capable of rotation through an arc defined by arrow 16. Likewise arm 15 is rotates through arc defined by arrow 17.

FIG. 3 shows with corresponding numbering an elevation view of the crank arm and pedal assembly 1 of FIGS. 1 and 2 in a second orientation. Pedal 22 has moved from the retracted position as shown in FIG. 2 to an extended position as shown in FIG. 3. This is highlighted by the eccentricity of centre point 25 of pedal platform 22 relative to axis point 7 of retaining member 9.

The simultaneous rotation of the swing arms 14 and 15 allows pedal platform 22 to move relative to retaining member 9 in the direction of arrows 23 and 24 (see FIG. 1). Swing arm 15 is preferably shorter than swing arm 14 and when oriented in a generally offset from vertical position as in FIG. 2, it causes pedal platform 22 16 to be at its closest proximity to crank centre axis 4 when crank arm 5 is oriented in a generally horizontal position according to FIG. 1. Swing arm 15 is significantly longer than arm 15 and is oriented in a generally vertical position and being in a position to immediately withstand and support any downward forces applied to pedal platform 22. When downward forces from a bike rider are applied to pedal platform 22, as swing arm 15 is shorter and positioned at an off vertical orientation, it does not offer any immediate vertical support to pedal platform 22 at its spigot connection point 13 until it is forced to swing or rotate down to a vertical position to accept and support downward forces as illustrated in the arrangement of FIG. 3. As the downward forces from pedal platform 22 are applied to spigot 13 of swing arm 15, this causes swing arm 15 to rotate down and about spigot 13 and to redirect the downward forces to provide a natural tendency due to the geometry of arms 14 and 15, to urge connected pedal platform 22 to move relative to retaining member 9, in a generally horizontal plane and in a forward direction shown by directional arrow 24 (see FIG. 1).

A Downward force is applied to pedal platform 22 preferably causes simultaneous rotation of swing arms 14 and 15, as they are connected to pedal platform 22. Swing arm 14 is significantly longer than swing arm 15 and is initially oriented in a vertical position according to the arrangement of FIG. 2. The vertical position offers little resistance to the required lateral movement of pedal platform 22 imposed by connected swing arm 15. In use swing arm 15 has a more dominant influence during rotation as it is significantly shorter that swing arm 14 and due to the initial orientation in an offset from vertical position, in operation swing arm 15 which is initially retracted, swings down and around and redirects downward forces to cause strong lateral movement to connected pedal platform 22 to cause it to be extended. The strong force from swing arm 15 overcomes any lateral resistance by swing arm 14 to allow the movement of pedal platform 22 in the direction of arrow 23 and 24 (see FIG. 1). Support for pedal platform 22 is shared by swing arms 14 and 15.

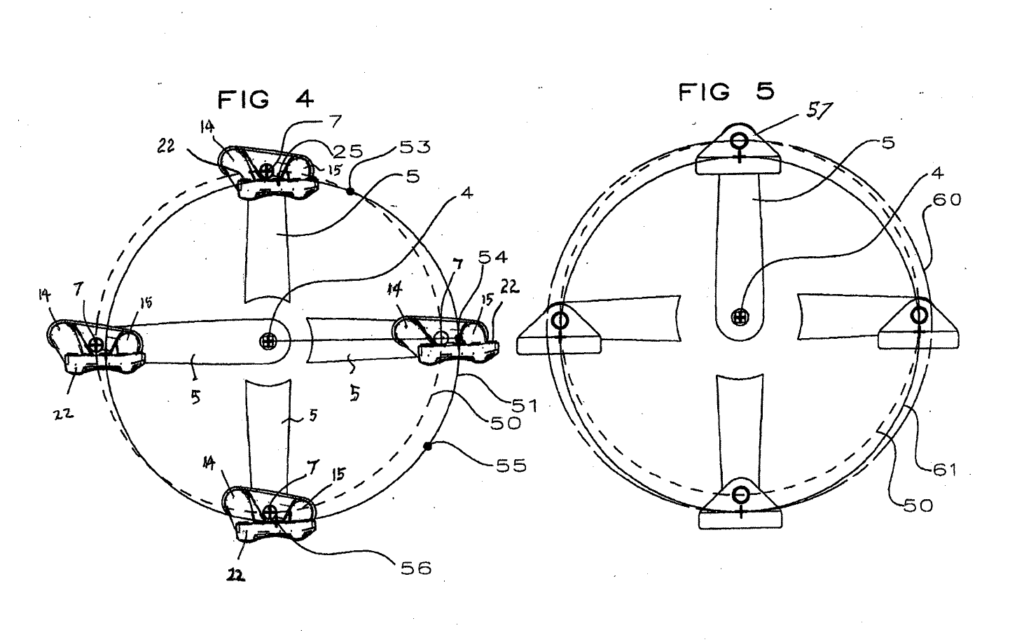

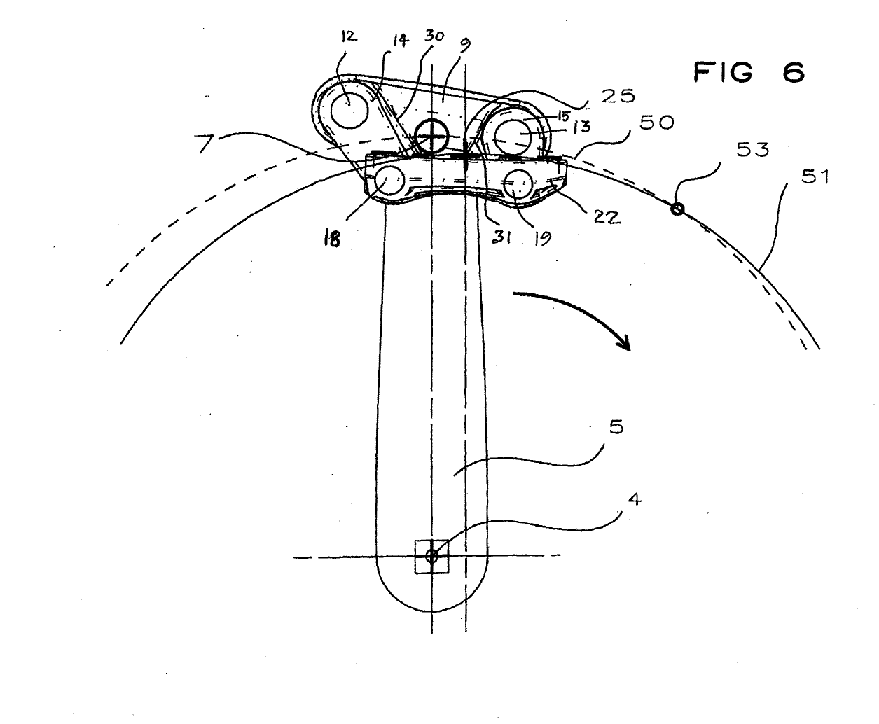

FIG. 4 shows an elevation view of the pedal assembly 1 mounted on a crank arm and the attitude of the pedal assembly 1 during stages of crank arm rotation through 90 degree increments and rotation circumferences of the conventional crank arm track 50 compared to the circumferential track 55 defined by the pedal assembly 1 according to the invention. When viewing crank arm 5 oriented vertically up, relative to crank arm axis 4 (see enlarged view in FIG. 6), it shows the swing arm mechanism of the pivot axis 7 to cause pedal platform 22 and centre point 25 to be positioned below and to the right of a spigot axis point 7 of a traditional pedal. This creates an alternate pedal track 51. The following describes a comparison between a traditional pedal track 50 and the pedal track 51 defined during rotation of the assembly according to the invention when fitted to an identical length crank arm 5 as shown FIG. 4. Pedal track 50 represents the track and circumference experienced by a traditional pedal and pedal track 51 represents the pedal track defined when the pedal assembly according to the invention rotates with the crank arm 5. Upon rotation of crank arm 5 the position of pedal platform 22 on pedal track 51 is closer to crank centre axis 4 than a spigot axis point 7 of a traditional pedal assembly 57 according to FIG. 5. This creates a fixed size and thus generates less torque. Upon rotation of crank arm 5 however, when axis point 25 of pedal platform 22, progresses along pedal track 51 to marker 53 where it intersects traditional pedal track 50, it effectively represents the same length crank arm as a traditional crank arm. Upon further rotation, as the pedal 22 travels along its pedal track 51 from marker 53 to the half way down position of marker 54, the crank arm 5 between these two markers in effect becomes progressively longer, as a result of pedal movement thereby, producing greater torque in a significant sector of the first quarter of the crank rotation. This is due to the increased moment arm created by the swing arm movement of pedal 22.

In FIG. 4, upon further rotation of pedal platform 22, from marker 54 to marker 55 in a second quadrant, according to pedal track 51 (see FIG. 4) and as in the first quadrant, pedal platform 22 also experiences a significant and progressive increase in effective crank arm length and torque. Since the repositioned pedal track about crank axis 4 is of identical circumference to the traditional pedal track 50 (see FIGS. 4 and 6). The pedal assembly according to the invention overcomes the prior art disadvantages of the known extending crank arm by providing means to increase torque without an increase in pedal track circumference. Upon further rotation of pedal platform 22 from pedal track marker 55 to marker 56 of pedal track 51 of FIG. 4, pedal track 51 shows a progressive reduction in effective crank arm length and resulting torque. Whilst some reduction of torque occurs between markers 55 and 56, it still creates significantly greater torque than that of the traditional crank arrangement. Upon reaching marker 56 of pedal track 51 of FIG. 4 which is the end of the second quadrant, crank arm 5 continues to rotate through a third and fourth quadrant. After the torque increase arc of rotation also the energy producing section of the crank arm rotation, pedal platform 22 and corresponding crank arm 5 continue rotation up through the third and fourth quarters of rotation, following by continued rotation.

FIG. 5 shows a prior art drop pedal assembly 57 and extending crank arm 5 defining a comparison of pedal tracks in 90 degree rotational increments. The drop pedal arrangement of the prior art produces less torque in the first quarter of rotation negating the gain of the second quarter. FIG. 5 shows a comparison of prior art pedal track 60 and 61 resulting from two different mechanisms designed to improve torque when compared to a traditional crank system. When the pedal track of the pedal assembly according to the preferred embodiment of the invention shown in FIG. 4 is compared to the prior art track shown in FIG. 5, the pedal track is progressively providing greater torque in both the first and second quarters of rotation without an increase in pedal track circumference.

When analysing the pedal tracks of the prior art according to FIG. 5, it shows the extending crank arm as pedal track 60 as gradually increasing from a traditional length crank arm when in the vertical or up position to a maximum at 90 degree position and then gradually decreasing back to a traditional length at the 180 degree position. Upon full rotation the second half mimics the first half to complete an oval shaped pedal track. The problem with the prior art extending crank arm arrangement is that whilst it provides an effective increase in crank arm length and torque, it also however, experiences a disadvantage of increased pedal track circumference. The drop pedal 57 according to pedal track 61, shows the problem of its pedal track providing less effective crank arm length and torque in the first quarter of rotation negating the effective increased crank arm length and performance of the second quarter. Upon riding a bicycle fitted with the pedal assembly according to the present invention, the feel for a rider is identical or at least virtually identical to that of a traditional crank system. The rider however as a result of the increased torque can select higher gears to negotiate slopes and experience less required pedal forces when compared to a traditional crank system.

FIG. 6 shows with corresponding numbering an enlarged elevation view of the pedal assembly 1 of FIG. 4 mounted on a crank arm 5 with the pedal assembly at the top of the arc of rotation of the crank arm 5. Retaining member 9 includes abutments 30 and 31 which according to the embodiment shown, limit the travel of respective swing arms 14 and 15. Abutment can be employed to determine limit of travel of arms 14 and 15 but they are non essential as travel is limited by the geometry of the swing arms which in the absence of abutments also limit travel of pedal 22 to a maximum extent. The extent of travel of pedal 22 are capable of small adjustments where the length of arms 14 and 15 are proportionately increased. Likewise this travel of pedal 22 can be reduced by a reduction in the proportionate lengths of the arms 14 and 15. The increase or decrease in length refers to the distance between a horizontal axis through spigot 12 and 18 in the case of arm 14 and between spigot 13 and 19 in arm 15.

It will be appreciated by those skilled in the art that the four combined axis points of swing arms 14 and 15 attached to retaining body 9 and pedal platform 25 Creates a geometry that causes pedal platform 25 to move forward and way from a fifth axis point, specifically spigot 6. It will be further appreciated by those skilled in the art that the five axis points created by axis 7, and spigots 12, 13, 18 and 19 creates a geometry that allows pedal platform 25 to move forward of a longitudinal axis through spigot 6 while inhibiting the potential of pedal platform 25 to roll forward while experiencing load from the riders legs. Adjustment can be made to illustrate this regime. If swing arms 14 and 15 were longer this would position pedal platform 25 lower. The pedal platform and swing arms assume a parallelogram geometry and can in this instance move further beyond the longitudinal axis through spigot 6 without a tendency to roll over. Alternatively, should the swing arms 14 and 15 be made shorter than the described length, pedal platform 25 would experience an unwanted forward roll over tendency.

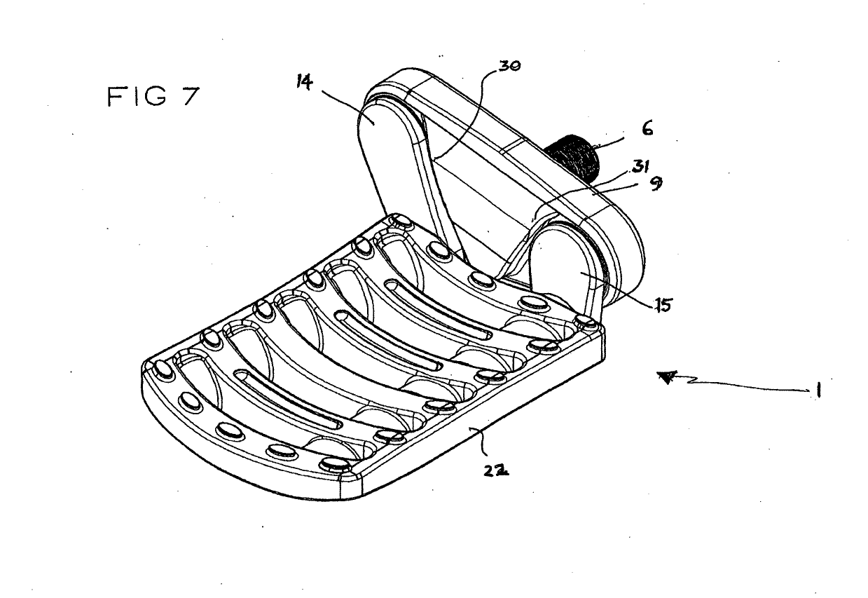

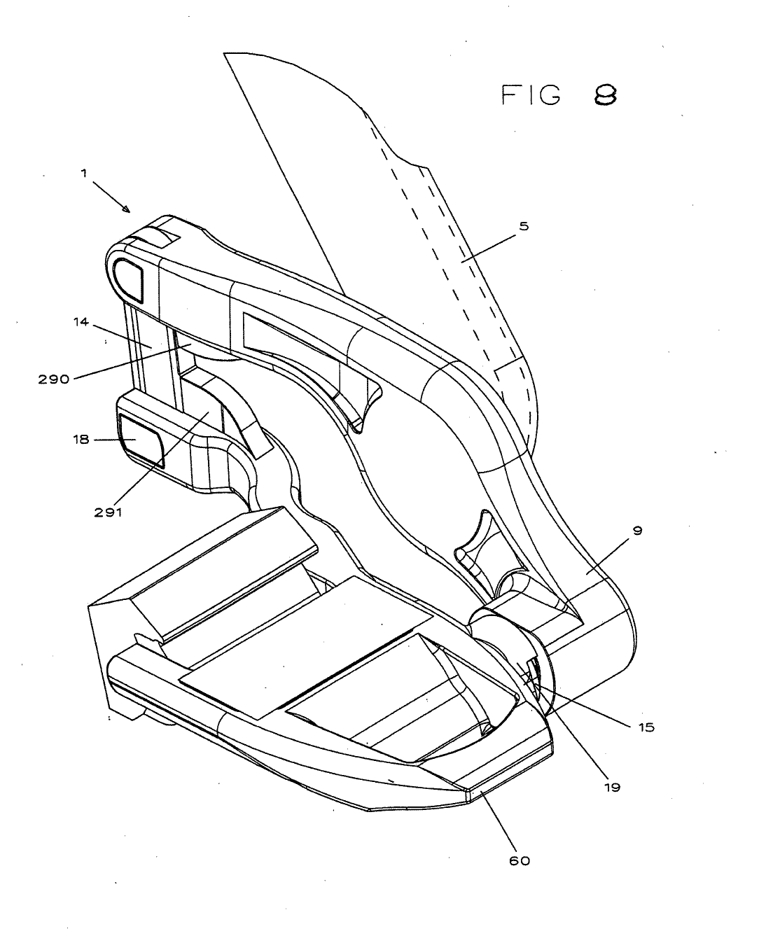

FIG. 7 shows with corresponding numbering a perspective view of the pedal assembly 1 of FIG. 1 assembled but isolated from the crank arm according to one embodiment.

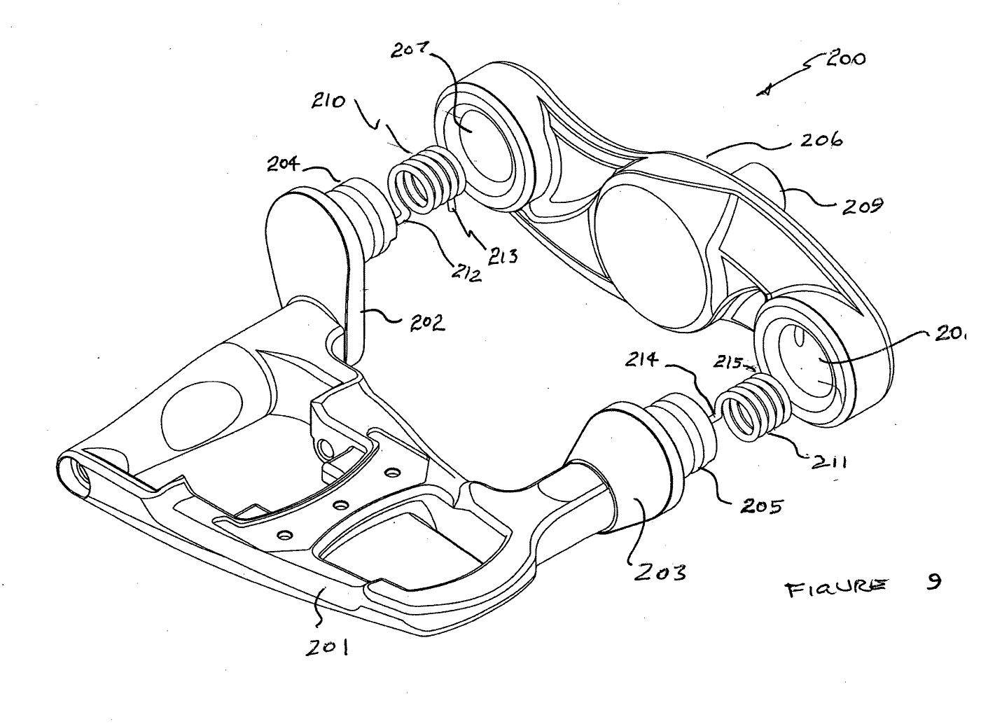

FIG. 8 shows an enlarged perspective view of a pedal assembly mounted on the crank arm 5 according to one embodiment with an alternative pedal 60.

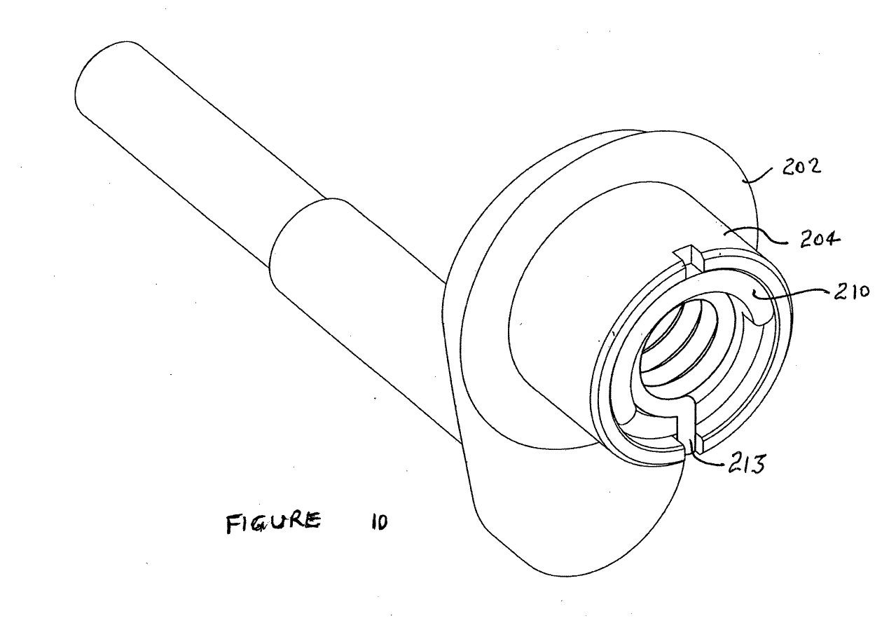

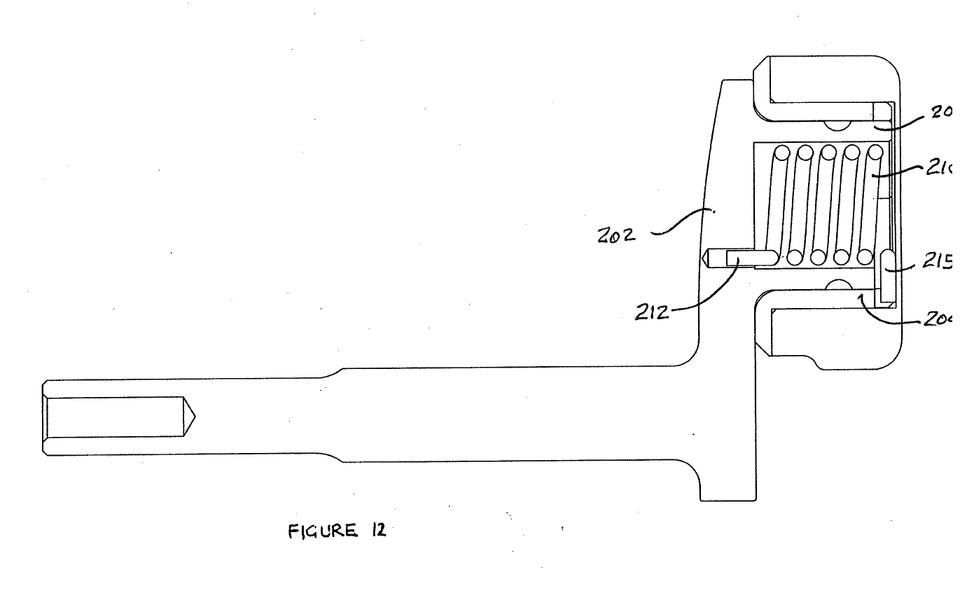

FIG. 9 shows a perspective view of a pedal assembly 200 according to an alternative embodiment. Pedal assembly 200 operates in a similar manner to that described for earlier embodiments in FIGS. 1-5 by includes an alternative means for dissipating energy of swing of the pedal during rotation, Pedal tread 201 terminates in spigot swing arms 202 and 203 from which respectively extend spigots 204 and 205. Retaining member 206 comprises a first opening 207 which receives spigot 204 and opening 208 which receives and retains spigot 205. Retaining arm 206 is mounted via axle 209 to a crank arm (not shown) in a similar manner to that described in earlier embodiments. Interposed between spigot 204 and retaining arm 206 is a tension spring 210. Also interposed between spigot 205 and retaining arm 206 is a second retaining spring 211. Spring 210 comprises at one end an engaging tang 212 and at an opposite end an engaging tang 213. Spring 211 comprises at one end an engaging tang 214 and at an opposite end an engaging tang 215 (partially obscured—see FIG. 12).

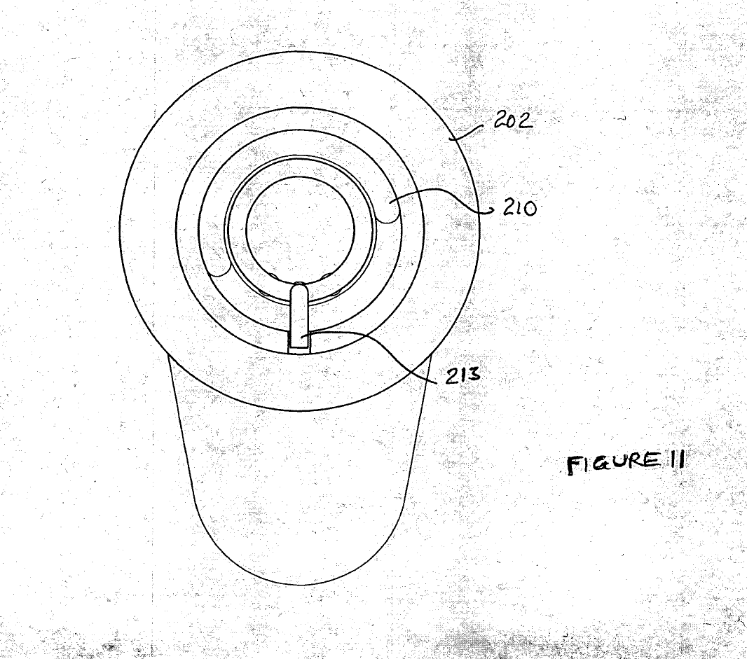

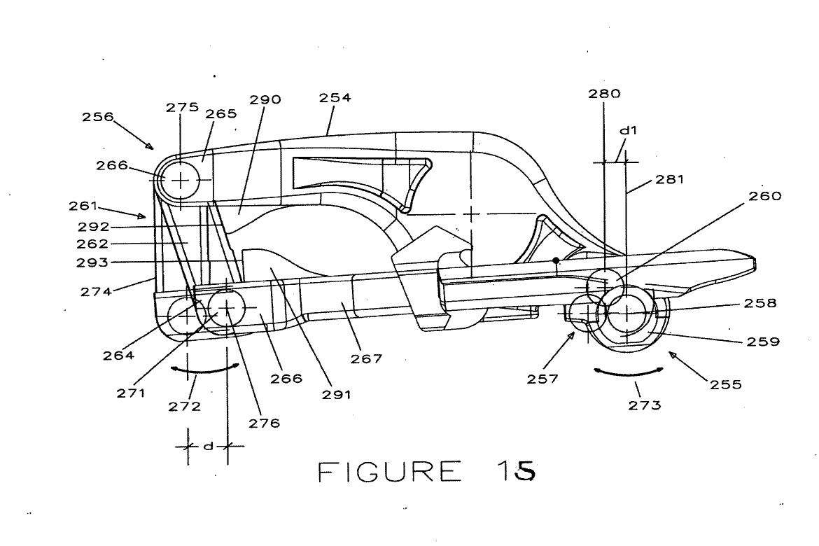

FIG. 10 shows with corresponding numbering an enlarged view of the spigot of the assembly of FIG. 16. FIG. 11 shows with corresponding numbering and end view of the spigot of FIG. 10.

FIG. 12 shows a side elevation view of the spigot 202 of FIG. 16. Spring 210 locates and is retained in spigot 204 which locates in opening 207 with tang 212 engaging a slot 216. Engagement between slot 216 and tang 212 secures end 218 of spring 210 against relative movement and ensures that spring 210 can accept and release spring tension induced during pedal strokes. Tang 213 at opposite end 220 of spring 210, engages a slot 221 (see also FIG. 10) which secures end 220 of spring 210 against relative movement and ensures that spring 210 can accept and release spring tension induced at end 220 during pedal strokes. Spring 211 engages spigot 205 in a similar manner.

The coil springs 210 and 211 are positioned within the spigots 204 and 205 of both swing arms to act as swing or energy dampers that help control the rapid movement experienced by a rider clip in platform 201 and swing arms 202 and 203 from an extended forward position, to a retracted back position when pedaling. Without the internal dampening springs 204 and 205, the rider can experience an abrupt or rapid movement of the pedal platform 201, when the rider pulls back on the extended to the retracted position, before pulling towards the upper most position. Alternately the rider can also experience a rapid movement from the retracted position when pulling up to the extended position, going over the top to commence the power stroke. The particular geometry of the swing arms 202, 203 and the combined action of the springs 204 and 205, eliminate the rapid or abrupt movement felt by the rider under foot. The springs 210 and 211 and particularly the leading swing arm 203 creates an optimal swing arm travel. To address the problem of the resistance of the spring, the front swing arm, when pulling back and up, the resistance of the spring tension, when the front arm travels back, creates enough resistance to stop the front arm, over centering upwards when pulling up at the retracted position. Without the spring to stop the front swing arm 203 over centering it feels very odd to the rider.

In use the spring 211 in the front swing arm, is designed to wind up and cause resistance (dampen) as the rider pulls back after the power stroke. Furthermore as the rider pulls up, the swing arm 203 has potential to swing up past the horizontal position. The tension of the spring 211 however, stops the swing arm 203 from rising above its horizontal position. As a result and in practice the combination of the swing arm 203 geometry and dampening spring 211, causes the rider to be unaware of the transition from the extended to retracted position when pedaling and from the retracted to extended position. After the pull up stroke, the rider pushes forward over the top, to commence the downward stroke. This causes a transition from the retracted to extended position, this movement causes the spring 210 of the longer back swing arm 202 to tension and resist (Dampen) the forward movement of the swing arm 202 and attached pedal platform 201.

The combination resistance of spring 210 and the natural geometry of the back swing arm 202 inhibits forward movement, to provide a progressive braking system of the swing arm 202 and connected pedal platform 201. This movement also causes the rider to feel a smooth transition from a retracted to extended position. The swing arm and internal spring combination and combined geometry of both swing arms to dampen pedal movement between extended and retracted and retracted and extended positions, applies equally to both swing arms.

To cause spring resistance and dampening to the front swing arm 203, the front swing arm is biased backwards to the retracted position. Alternately, to cause spring resistance to the back swing arm 202, it is biased forward to the extended position. As a result there is some cancelling of the effects of the springs particularly during mid travel. As a result of this however, the springs are most effective towards the ends of swing arm travel. This is particularly useful to stop the front swing arm 203 from pulling up over centre.

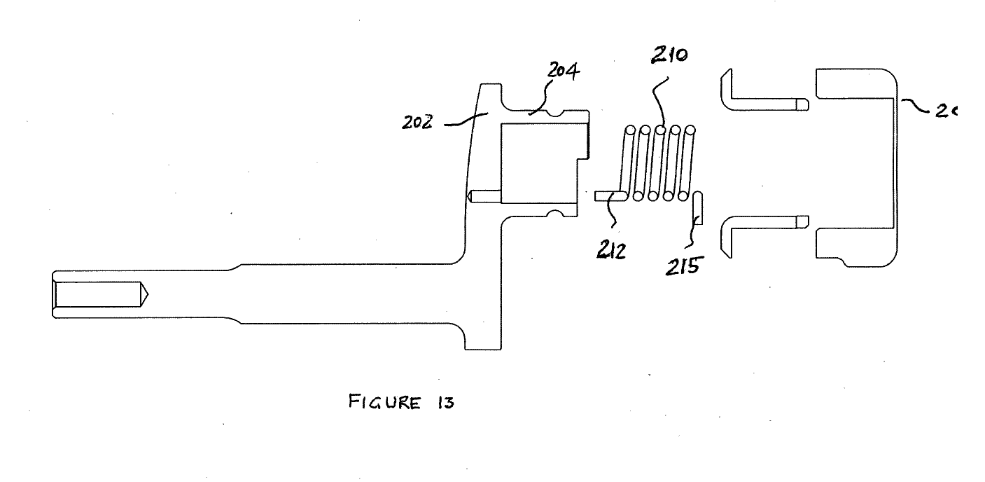

FIG. 13 shows an exploded side view of swing arm 202 of the pedal assembly 200 of FIG. 16.

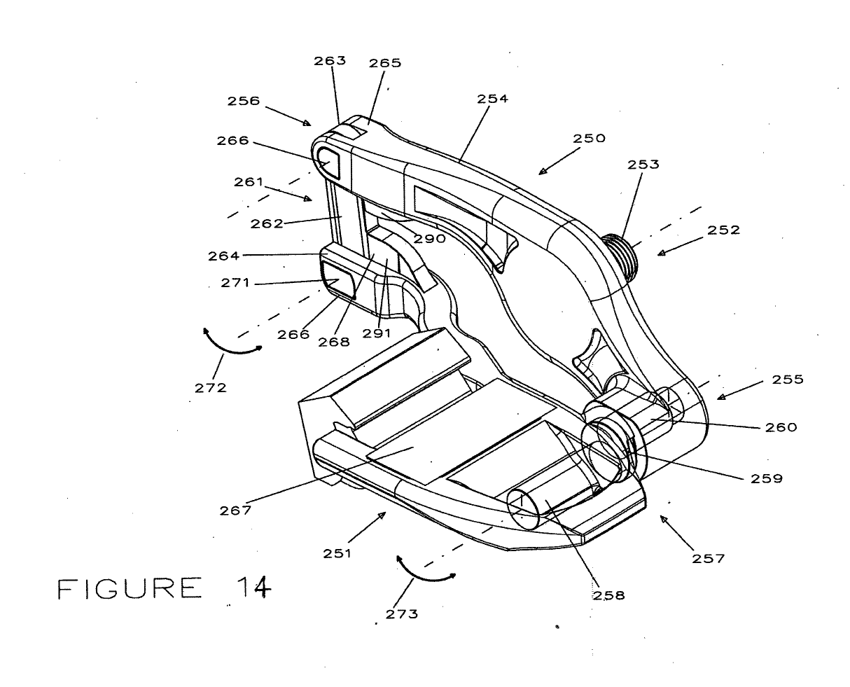

FIG. 14 shows a perspective view of a pedal assembly 250 according to an alternative embodiment. FIG. 14 shows an alternative racing bike pedal which is arranged to avoid a pedal roll over tendency (i.e. a tendency for the pedal to tilt down rather than remaining substantially level. This stops the riders foot also rolling over with the pedal. The racing pedal of FIG. 14 embodies the optimal geometry of that described with reference to FIG. 6 including the five axis points of connection of the swing arms and connection of the pedal assembly to the crank arm. This retains an operational geometry which accommodates pedaling techniques of racing cyclists.

Referring to FIG. 14 there is shown a perspective view of a bicycle pedal assembly 250 including a pedal assembly 251 according to a preferred embodiment. Spigot 252 engages a crank arm (not shown but similar to crank arm 5 in FIG. 1) via a thread 253. Spigot 252 is retained within a bearing located within retaining member 254. Spigot 252 connects the pedal assembly 250 to the crank arm (such as crank arm 5 in FIG. 1). A bearing retained within retaining member 254 allows rotation of retaining member 254 relative to spigot 252 which is fixed to crank arm 5. Retaining member 254 comprises a first end 255 and second end 256. First end 255 includes an offset coupling 257 formed from a first spigot 258 which is retained eccentrically on plate 259 and a second spigot 260 which is inserted in retaining member 254. End 256 of retaining member 254 comprises a coupling assembly 261 Coupling 261 comprises a linkage member 262 having a first end 263 and second end 264. First end 262 engages a slot 264 of a bifurcated formation 265 and is retained therein via pivot pin 266 thereby enabling linkage member 262 to swivel relative to the retaining member 254. Second end 264 engages a bifurcated formation 266 of pedal 267 which defines a slot 268 which receives and retains linkage member 262 via pivot pin 271. FIG. 15[22] shows a side elevation view of the pedal assembly 250 of FIG. 14[21] with the pedal advanced forward.

It can be seen from this view that pedal 267 can advance and retract in the directions indicated by arrows 272 and 273. Coupling 256 is shown with linkage member 262 advanced distally from its proximal position indicated by dotted line 274. Pin 266 has a central axis 275 and pin 271 has a central axis 276. When pedal 269 is at its maximum distal extent axis 276 is disposed at a distance d from axis 275. Distance d indicates the extent of travel of pedal 267 during rotation of pedal 267 about a drive axis. Coupling 257 is shown with spigot 258 advanced distally. Spigot 258 has a central axis 280 and spigot 260 has a central axis 281. When pedal 269 is at its maximum distal extent axis 281 is disposed at a distance d1 from axis 280. Distance d1 also indicates the extent of travel of pedal 267 during rotation of pedal 267 about a drive axis.

FIG. 16[23] shows an elevation view of the pedal assembly 250 of FIGS. 14 and 15 mounted on a crank arm 282 and the attitude of the pedal assembly 250 during stages of crank arm rotation through 90 degree increments between 0-360 degrees and rotation circumferences of the conventional crank arm track 285 compared to the circumferential track 286 defined by the pedal assembly 250 according to the invention. When viewing crank arm 282 oriented vertically up, relative to crank arm axis 287 it shows axis 276 at the end 164 of linkage arm 262 forward relative to axis 275 of pivot 266. This takes the pedal assembly 250 through an alternate pedal track 286. The following describes a comparison between the traditional pedal track 285 and the pedal track 286 defined during rotation of the assembly 250 when fitted to an identical length crank arm 282. Pedal track 285 represents the track and circumference experienced by a traditional pedal and pedal track 286 represents the pedal track defined when the pedal assembly 250 according to the invention rotates with the crank arm 282. Upon rotation of crank arm 282 the position of pedal platform 267 on pedal track 285 is closer to crank centre axis 287 than a traditional pedal assembly. Upon rotation of crank arm 282, when axis point 288 of pedal platform 267, progresses along pedal track 285 to where it intersects traditional pedal track 286 at location 289. At this point, it effectively represents the same length crank arm as a traditional crank arm. Upon further rotation, as the pedal 267 travels along its pedal track 285 from 289 to the half way down position at 296, the crank arm 282 between these two markers in effect becomes progressively longer, as a result of pedal movement, thereby producing greater torque starting at around 20 degrees into the first quadrant of the crank rotation. This is due to the increased moment arm created by the forward movement of pedal 267. Upon further rotation of pedal platform 267, from marker position 296 to the second quadrant, according to pedal track 286 and as in the first quadrant, pedal platform 267 continues to experience a significant and progressive increase in effective crank arm length and the torque so generated. This occurs up to a location in the crank arm travel about 125 degrees or approximately 23 past 12 on a clock face. The pedal assembly 250 according to the invention overcomes the prior art disadvantages of the known extending crank arms by providing means to increase torque without an increase in pedal track circumference. Upon further rotation of pedal platform 267 from pedal track location 296 to location 291 there is a gradual reduction in effective crank arm length and resulting torque. Whilst some reduction of torque occurs between markers 297 to 298, pedal assembly 250 still creates significantly greater torque than that of a traditional crank arrangement. Upon reaching location 298 of pedal track 286—i.e. the end of the second quadrant, crank arm 282 continues to rotate through a third and fourth quadrant. After the torque increase in the first two quadrants pedal platform 267 and corresponding crank arm 282 continue rotation up through the third and fourth quadrants. Pedal assembly 250 in the first and second quadrants allows gradually increasing torque (compared to a conventional pedal connected directly to the crank arm) from a location about 20 degrees through to a location about 120 degrees after which torque starts to decrease as the crank arm heads towards quadrant three.

When the pedal assembly 250 advances from the second to the third quadrant on an increasing upward track during rotation of the crank arm, the pedal track 290 gradually decreases from the crank centre while creating greater torque until it intersects pedal track 285 about halfway along the third quadrant at which point the torque continues to decrease during the remaining third quadrant. In practice the torque produced by pulling up in the third quarter of rotation is similar to a traditional crank arm. This is due to the equalization of additional torque produced in the first half of the third quadrant and less torque in the second half of the third quadrant as demonstrated by following track 286. Upon further rotation during the fourth quadrant the pedal track of pedal assembly 250 shows a gradual decreasing of its pedal track compared to a conventional pedal track and a resulting torque loss during the fourth quadrant. This does not subtract from mechanical advantage as during the fourth quadrant, a rider contributes the least energy or pedal pressure. Pedal assembly provides advantage and improvement over the known extendable crank arms by enabling an increase in torque without an increase in pedal track circumference.

The assembly 250 of FIG. 14 differs from the arrangement of that in FIG. 1 in that in the former an alternative to swing arms (FIG. 1) is used to generate the relative movement between retaining arm 254 and pedal platform 267 causing forward extension. A rider's foot on a racing pedal embodiment of FIG. 14 is during crank arm rotation pre positioned 16 mm further forward of the axis through spigot 253. In the case of a racing pedal, five axis points through axes through spigot 253, pin 266, pin 266a of linkage member 262, and through spigot 258 and 260 of offset coupling 257, resists a tendency of the rider's foot to roll over. In practice a riders foot positioned about 16 mm forward provides increased leverage and torque. The downward force of the riders foot causes the spigot 258 of offset coupling 257 to an eventual vertical downward position to accept load unevenly shared with link arm 262. The relatively short offset of spigot 258 of offset coupling 257 allows about 6 mm of extension of platform 267. This also restricts the travel of platform 267 to around 16 mm forward when the coupling axes are in vertical alignment. The relatively small offset in coupling 257 is required to control abrupt directional changes of forces experienced by pedal platform 267 such as pushing and pulling of the rider's foot during crank arm rotation. In practice the relatively short offset of coupling 257, controls the majority of pedal extension movement during pedaling. As shown in FIG. 16 a first abutment 290 is provided on retaining arm 254. This obstructs linkage 262 during forward travel of pedal 267 and provides a limit of travel in the forward direction by engagement of linkage member 262 with surface 292. Abutment 291 provides a limit of travel in the aft direction by engagement between abutment surface 293 and linkage member 262. Linkage member 262 can be provided with different thicknesses to alter interference between the abutments and linkage members.

When the pedal track 286 of the pedal assembly according to the preferred embodiment of the invention is compared to the conventional pedal track 285 shown in FIG. 22, the pedal track is progressively providing greater torque in both the first and second quarters of rotation without an increase in pedal track circumference. When using the pedal assembly 250 according to the present invention, the rider does not notice a difference in feel as that is virtually identical to that of a traditional crank system. The rider however as a result of the increased torque can select higher gears to negotiate slopes and experience less required pedal forces when compared to a traditional crank system.

Once crank arm 282 reaches a vertical down position a pulling up action of a riders foot generates vertical and horizontal (rearward) components of force causing linkage arm 262 and spigot 258 to displace rearwardly to a retracted position during the third and fourth quarters of rotation. When using a pedal clip on pedal platform 267 during the clockwise return upstroke a greater torque from the clip on pedal is created during rotation from the end of the second quadrant of rotation (6 O'clock position) to the end of the third quadrant of rotation—i.e. when the pedal platform has reached 270 degrees of rotation from its vertical start point. The similar torque gained in the third quadrant by use of the clip on is not present or required during rotation through the fourth quadrant. As a result of pedal movement this, produces greater torque in a significant range of the first and second quarters of the crank rotation due to the increased moment arm created by the extension or advancement of pedal 267. This is a potentially helpful mechanical advantage in racing bicycles where additional torque is provided at the points it is most required. This is achieved without altering the pedal track circumference.

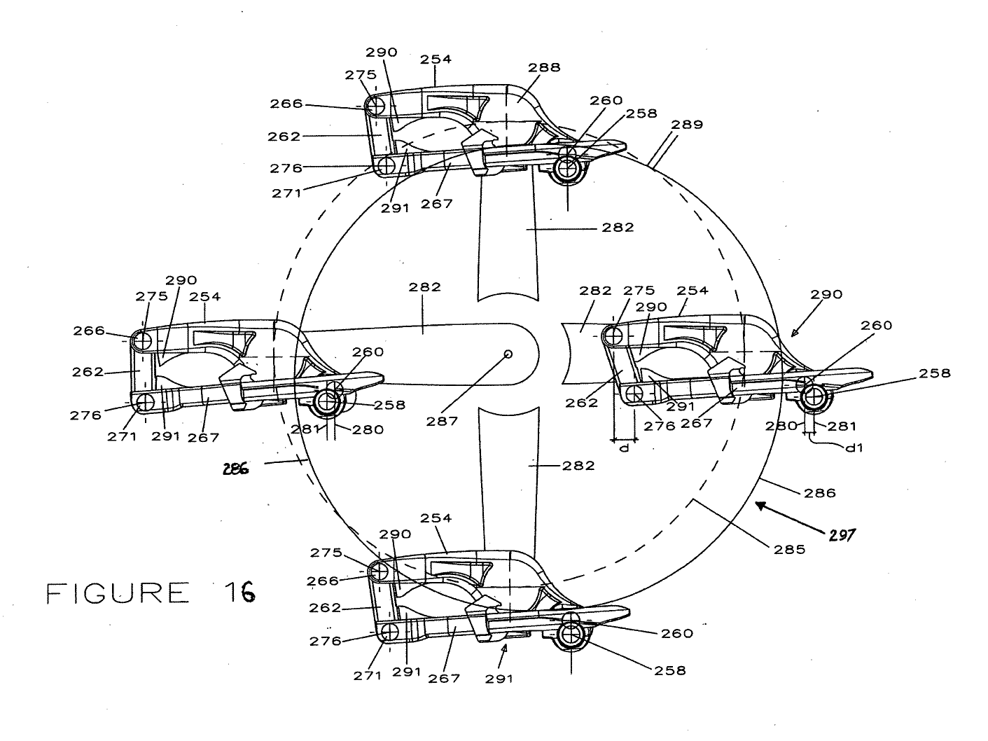

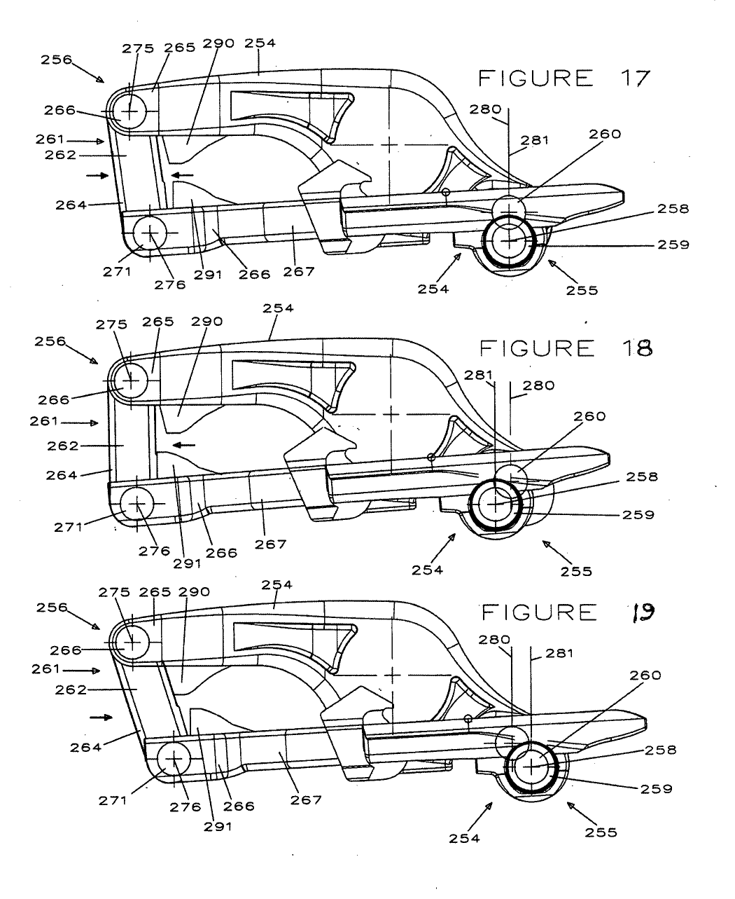

FIG. 17 shows with corresponding numbering an enlarged side elevation view of the pedal assembly 250 of FIG. 14 with the pedal 267 as it appears when the crank arm 282 is at the 12 and 6 o'clock positions. FIG. 18 shows with corresponding numbering an enlarged side elevation view of the pedal assembly of FIG. 21 with the pedal 250 as it appears when the crank arm 282 is at the 9 o'clock position. FIG. 19 shows with corresponding numbering an enlarged side elevation view of the pedal assembly 250 of FIG. 21 with the pedal 267 as it appears when the crank arm 282 is at the 3 o'clock position.

The present invention provides a pedal assembly including a compact mechanism which imparts increased torque compared to the prior art assemblies by enabling a pedal rotation track which includes a region of increased moment and therefore mechanical advantage. Furthermore, the invention harnesses natural occurring forces applied by a rider to provide a region of increased moment. The pedal assembly employs a rocking arm mechanism with a minimum of low stress moving parts and no gears. Furthermore, the pedal assembly undergoes relatively small displacement for a significant increase in torque during a riders' pressure stroke compared to the torque applied to the crank arm in a conventional pedal assembly. Also the working life of the pedal assembly is comparable to that of conventional pedals. The small displacement during rotation reduces wear and tear and maintenance in comparison to traditional pedal assemblies. It will be appreciated to those skilled in the art that the invention is adaptable to existing crank arms by retrofitting.

According to one embodiment the displacement of the swing arms is preferably about 15 mm and when the crank arm reaches the end of the first quadrant the pedal it at its maximum displacement at about halfway through the second quadrant of rotation with a significant torque increase at that point. In practice, the seat of the bicycle is oriented above and somewhat behind the crank arms and primary drive assembly. This orientation causes the rider's legs to push away from the seat with a resultant force which has forward and downward components.

A rider's seat can be adjusted to select a preferred knee height during rotation. Furthermore the ground clearance of the average bicycle is more than adequate to allow for the marginally increased travel caused by the swing arm and pedal tread mechanism. The pedal assembly can be retrofitted to existing bicycles. This increased moment arm allowed by the pedal assembly gives the rider a mechanical (torque) advantage for the same effort that would be required on a conventional bike and with no change to circumferential length.

Maximum mechanical advantage preferably coincides with the position at which the riders legs are strongest usually just short of full extension to take advantage of the pedal assembly at the full advancement of the pedal. An advantage of the invention is that the mechanical advantage of an increased torque is achieved with a minimum of parts, with an assembly taking up a relatively small space, which is lightweight, simple and inexpensive to manufacture. The effective increase in crank arm length obtained by the assembly of the invention increases torque during rotation of the crank arm and the increase occurs through an arc of crank arm rotation that when rider applied load is experienced a significant increase in torque occurs compared to the same load applied to a conventional pedal and fixed length crank arm. Also, using the pedal assembly according to the embodiments of the invention described, ground clearance is not compromised on the down stroke of the pedal.

It will be recognised by persons skilled in the art that numerous variations and modifications may be made to the invention as broadly described herein without departing from the over spirit and scope of the invention.

The claims defining the invention are as follows:

1. A pedal assembly mountable on a bicycle crank arm associated with a bicycle drive assembly; the pedal assembly comprising:
a pedal which is operably connected to a retaining member; the retaining member including a first end and a second end and on one side a spigot which engages the crank arm to enable support of the pedal assembly by the crank arm;
the pedal including a first connection which engages the first end of the retaining member and a second connection which engages the second end of the retaining member; wherein the first and second connections allow the pedal to move relative to the retaining arm during rotation of the crank arm.

2. A pedal assembly according to claim 2 wherein, movement of the pedal relative to the retaining member allows the pedal to advance and retract during rotation of the crank arm.

3. A pedal assembly according to claim 2 wherein, the first connection comprises an offset coupling having a shaft which engages an opening in the retaining member.

4. A pedal assembly according to claim 3 wherein, the connection has a bearing arranged to allow the pedal to advance at least in a forward direction during rotation of the crank arm.

5. A pedal assembly according to claim 4 wherein, the first connection allows the pedal to also advance in an upward direction during rotation of the crank arm.

6. A pedal assembly according to claim 5 wherein, the second connection comprises a first pivot which joins a part of the pedal to a first end of a link arm and a second pivot which joins a second end of the link arm to a part of the retaining member.

7. A pedal assembly according to claim 6 wherein, the link arm engages the part of the pedal via a bifurcation formed at a free end of the pedal.

8. A pedal assembly according to claim 7 wherein, the link arm engages the retaining member via a bifurcation in the second end of the retaining member.

9. A pedal assembly according to claim 8 wherein the link arm is arranged so that it advances and retracts during rotation of the crank arm.

10. A pedal assembly according to claim 9 wherein the retaining member includes an abutment which restricts movement of the link arm in one direction.

11. A pedal assembly according to claim 10 wherein the pedal includes an abutment which restricts movement of the link arm in one direction.

12. A pedal assembly according to claim 11 wherein, the abutment on the retaining member restricts travel of the linkage arm in a forward direction.

13. A pedal assembly according to claim 12 wherein the abutment on the pedal restricts travel of the linkage arm in a rearward direction.

14. A pedal assembly according to claim 13 wherein the linkage arm is rotatable relative to a pin retained in the pedal bifurcation.

15. A pedal assembly according to claim 14 wherein the linkage arm is rotatable relative to a pin retained in the retaining member bifurcation.

16. A pedal assembly according to claim 15 wherein, the spigot joining the retaining member to the crank arm extends from the retaining member at a location approximately one third the length of the retaining member measured from the first end.

17. A pedal assembly according to claim 16 wherein the first end of the retaining member is a leading end and the second end is a trailing end.

18. A pedal assembly according to claim 17 wherein, during rotation of the crank arm from 0-12 o'clock the first and second pedal assembly connections allow the pedal to at least partially rotate relative to the retaining member.

19. A pedal assembly according to claim 18 wherein as the crank arms rotate an increase in rider applied torque is achieved while the pedal defines during rotation of the crank arm a rotational circumference substantially the same as that defined by a pedal connected directly to the crank arm.

20. A pedal assembly according to claim 19 wherein the spigot extending from the retaining member is retained by a thread on the crank arm.

21. A pedal assembly according to claim 20 wherein the retaining member includes a bearing which allows the retaining member to rotate relative to the spigot when retained in the crank arm.

22. A pedal assembly according to claim 21 wherein as the crank arm rotates about a drive axis, the pedal moves between a first location in which the pedal has extended forward relative to the retaining member and a second location in which the pedal extends proximally relative to the retaining member.

23. A pedal assembly connectable to a bicycle crank arm; the pedal assembly comprising a pedal body which includes a tread which receives a rider's foot; a retaining member which receives and retains the pedal body and is connected via a spigot to said crank arm, the retaining member having a first and second end, the first end including a coupling which retains a part of the pedal body to the retaining member, the second end including a coupling which retains another part of the pedal body; the first end coupling comprising an offset spigot which allows the pedal to move relative to the retaining member; the second end coupling comprising a link arm which engages the pedal and the retaining member and allows the pedal to move relative to the retaining member; wherein as the crank arm rotates during riding of the bicycle, the pedal moves relative to the retaining member such that at least for part of a revolution of the crank arm the pedal alters its position relative to the retaining member forward and rearward.

24. A pedal assembly according to claim 23 wherein as the crank arm rotates about a drive axis, the pedal which is connected to the retaining member, moves between a first location in which at least part of the pedal is extended distally relative to the crank arm to a maximum extent and a second location in which the pedal is retracted.

25. A pedal assembly according to claim 24 wherein the linkage arm has a first end which engages the retaining member via a first pivot pin and a second end which engages a part of the pedal via a second pivot pin.

26. A pedal drive assembly for a bicycle; the assembly comprising a pair of crank arms each having a first end connected to a drive shaft and a second end connected to a pedal assembly; the pedal assembly including a pedal body mounted to a retaining member via swivel connections, the swivel connections allowing each pedal body to at least partially rotate relative to the retaining member; wherein as the crank arms rotate an increase in torque is achieved by advancing of the pedal during at least part of the arc of rotation of the crank arms, while maintaining a rotational circumference substantially the same as that defined by a pedal connected directly to the crank arm.

27. A pedal assembly according to claim 26 wherein the retaining member includes an abutment which limits travel of the pedal in one direction.

28. A pedal assembly according to claim 27 wherein the retaining member includes an abutment which limits travel of the pedal in a forward direction.

29. A pedal assembly according to claim 28 wherein the pedal includes an abutment which limits travel of the pedal in one direction.

30. A pedal assembly according to claim 29 wherein the pedal includes an abutment which limits travel of the pedal in a backwards direction.

31. A pedal assembly according to claim 1 wherein the pedal is connected to the retaining member via first and second swing arms which each pivot relative to the retaining member at a first end.

32. A pedal assembly according to claim 31 wherein the swing arms each pivot at a second end relative to the pedal, wherein the first and second swing arms allow the pedal to advance and retract relative to the retaining arm during rotation of the crank arm.

33. A pedal assembly according to claim 32 wherein the swing arms are each located in respective recesses on the retaining member; the recesses each having an abutment surface which limits the travel of the swing arms to thereby limit advancement and retraction of the pedal during rotation of the crank arm.
